(19) United States
(12) Patent Application Publication
(10) Pub. No.: US 2011/0270957 A1
(43) Pub. Date: Nov. 3, 2011

(54) METHOD AND SYSTEM FOR LOGGING TRACE EVENTS OF A NETWORK DEVICE

(76) Inventors: The PHAN, Roseville, CA (US); Gregory D. Dolkas, Auburn, CA (US); Serge Zelenov, Sacramento, CA (US)

(21) Appl. No.: 12/771,868

(22) Filed: Apr. 30, 2010

(51) Int. Cl. G06F 15/173; G06F 15/177

(52) U.S. Cl. 709/221; 709/224

(57) ABSTRACT

A method for logging trace events of a network device in a network is described herein. A plurality of log events may be generated based on a source level. The plurality of log events is stored to a log buffer of the network device. The log buffer is monitored for a trigger event, which is a condition in the network. It is determined whether the trigger event is detected. Upon detecting the trigger event, one or more log events of the plurality of log events in an ex-ante window of the log buffer are determined. A log event of the one or more log events is provided to a system log. Upon determining the trigger event is not detected, it is determined whether the one or more log events of the plurality of log events in the ex-ante window satisfy a log level. A severity of the source level is lower than a severity of the log level.

### I. BACKGROUND

In conventional network computing environments, a number of network devices are used to efficiently transfer data over the network, for example to and from network nodes. Routers and switches are in general network devices which segregate information flows over various segments of a computer network. Unless otherwise indicated, the phrase “network devices” includes both network-attached devices (e.g., network management systems) and network infrastructure devices.

The network devices may be monitored for conditions that warrants administrative attention. Thus, when an anomaly is detected, a network administrator may review an event record that describes any network problem that disrupts or threatens to disrupt the exchange of information.

Typically, network devices log events to a local system log and replicate the events to a Syslog server or send it as a trap to Simple Network Management Protocol (SNMP) management servers, which are monitored by the network administrator.

In a network with hundreds or thousands of network devices, each of which provide their log events to a central server, effective management of the log data is difficult. When an anomaly is detected, it is a burdensome task for the network administrator to locate relevant log events in the vast collection of log data.

Other approaches reduce the number of logged events collected. For example, a policy may dictate that important log events are retained and less important log events are discarded. By the time an anomaly is detected, the system is unable to capture sufficient trace data that may be used for diagnosis of the network anomaly. Still other approaches require the network administrator to reconfigure the system to enable logging at a more detailed level so as to capture the relevant information at the next occurrence of the anomaly. This is an iterative process that requires many manual and error prone steps, and is highly disruptive to the network environment. In scenarios where the failure is observed in a single occurrence or when the production environment may not be disturbed for test purposes, an iterative process may not be a feasible option.

### II. BRIEF DESCRIPTION OF THE DRAWINGS

The present disclosure may be better understood and its numerous features and advantages made apparent to those skilled in the art by referencing the accompanying drawings.

FIG. 1 is a topological block diagram of a network system in accordance with an embodiment of the invention.

FIG. 2 is a process flow diagram for logging network operation data in accordance with an embodiment of the invention.

FIG. 3A is a simplified diagram of a log buffer in accordance with an embodiment of the invention.

FIG. 3B is a simplified diagram of a flow of log events in accordance with an embodiment of the invention.

FIG. 4 is a block diagram of an exemplary switching or routing device in accordance with an embodiment of the invention.

FIG. 5 illustrates an exemplary computer system in which various embodiments of the present invention may be implemented.

### III. DETAILED DESCRIPTION OF THE INVENTION

Since network devices, such as network switches and routers, are limited in storage space, detailed trace data of the operations of network devices are typically not logged. When a failure initially occurs in the network, the logged events may not provide sufficient information to troubleshoot the problem. Moreover, the opportunity to capture the relevant trace information may be lost after the initial occurrence of the failure.

As described herein, a log buffer may be implemented at the network device to capture relevant log events for a defined window, the size of which may be measured in time and/or number of log events. As used herein, a log event is a record of operational data about a network infrastructure device. In one embodiment, a time stamp of when the log event occurred is associated with every log event. The window includes an ex-ante portion (hereinafter, “ex-ante window”) which captures log events before the occurrence of an event trigger. As used herein, an event trigger is a condition that may warrant administrative attention, such as a network anomaly, disruption, security threat, and the like. The window also includes an ex-post portion (hereinafter, “ex-post window”) which captures log events after the occurrence of the event trigger. Either the ex-ante window or the ex-post window may also include the log event giving rise to the detection of the event trigger. Log events which are deemed relevant during a filtering process may be provided to Syslog (i.e., a local system log and/or a Syslog server). As such, the relevant trace data may be retained without occupying large amounts of disk and/or memory space.

A method for logging trace events of a network device in a network is described herein. A plurality of log events may be generated based on a source level. The plurality of log events is stored to a log buffer of the network device. The log buffer is monitored for a trigger event, which is a condition in the network. It is determined whether the trigger event is detected. Upon detecting the trigger event, one or more log events of the plurality of log events in an ex-ante window of the log buffer are determined to be relevant for trace data. In one embodiment, all log events in the ex-ante window are considered relevant for trace data. A log event of the one or more log events is provided to a system log. Upon determining the trigger event is not detected, it is determined whether the one or more log events of the plurality of log events in the ex-ante window satisfy a log level. A severity of the source level is lower than a severity of the log level.

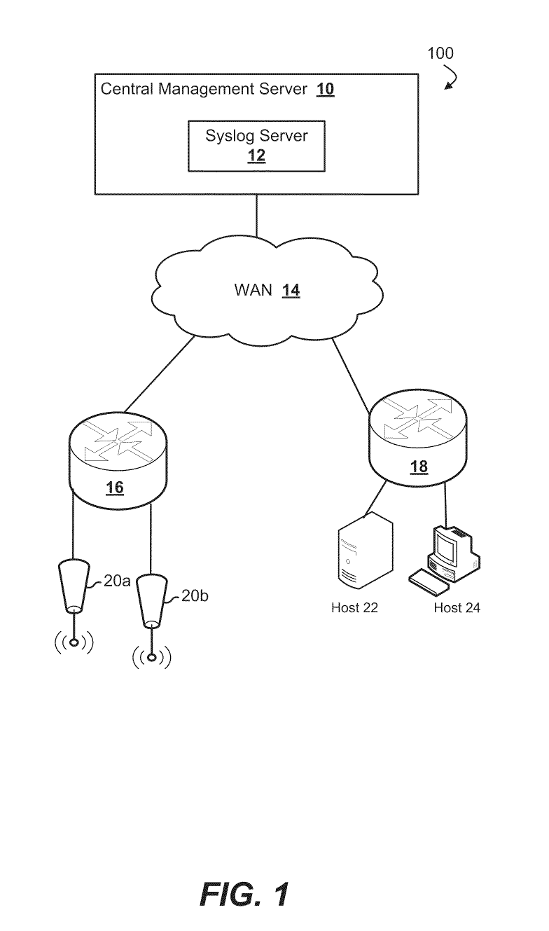

FIG. 1 is topological block diagram of a network system in accordance with an embodiment of the invention. Network 100 includes a central management server 10, a wide area network (WAN) 14, a network switch 16, a network switch 18, a wireless access point 20a and a wireless access point 20b (collectively referred to as wireless access points 20), a host 22, and a host 24.

Central management server 10 is configured to plan, deploy, manage, and/or monitor a network, such as network 100. Central management server 10 is operatively coupled to network switch 16 and network switch 18 via WAN 14. The connection between central management server 10 and network switches 16 and 18 may include multiple network segments, transmission technologies, and components.

Central management server 10 includes Syslog server 12, which is configured to collect and/or integrate log events reported by one or more network infrastructure devices, such as network switch 16 and network switch 18. In another embodiment, Syslog server 12 is a standalone device or is integrated into another device in network 100.

Network switch 16 is operatively coupled to central management server 10 via WAN 14. Network switch 16 includes multiple ports, one or more of which connect to wireless access points 20.

Network switch 18 is operatively coupled to central management server 10 via WAN 14. Network switch 18 includes multiple ports, one of which connects to host 22 and another of which connects to host 24.

In one embodiment, network switch 16 and network switch 18 are configured to process and transfer data in a network. Additionally, network switch 16 and network switch 18 may be further configured to detect a trigger event occurring in the network device and provide, to Syslog server 12, log events from an ex-ante window and an ex-post window in a log buffer of the network device, for example as a report message. The report message may be used by central management server 10 for troubleshooting and other purposes.

Wireless access points 20 are configured to connect a wireless client to a wireless network. Wireless access points 20 are operatively coupled to network switch 16. The connection between network switch 16 and wireless access points 20 may include multiple network segments, transmission technologies, and components.

Host 22 is a server and is operatively coupled to network switch 18. Host 24 is a personal computer and is operatively coupled to network switch 18. The connection between network switch 18 and host 22 and host 24 may include multiple network segments, transmission technologies and components.

In operation, one or more of network switch 16 and network switch 18 may include a local system log and a log buffer. Typically, network devices are configured to log events at an administrator-selected log level. As used herein, log levels specify the level of severity of an event and/or the level of granularity or detail with which events are logged. For example, log levels may include (in decreasing severity):
EMERGENCY, which may indicate the device reporting the log event is unusable such as in an emergency condition;
ALERT, which may indicate that action must be taken immediately to address a condition;
CRITICAL, which may indicate that a critical condition has occurred;
ERROR, which may indicate an error has occurred;
WARNING, which may indicate a significant event that may require attention has occurred;
NOTICE, which may indicate a significant, but normal, event has occurred;
INFO, which may indicate an insignificant, but normal, operation has occurred;
DEBUG, which may include diagnostic information about operations.

Typically, the lower log levels, such as DEBUG and INFO, are not of interest to network administrators. As such, network devices are configured to log events at higher log levels, such as EMERGENCY, ALERT, or CRITICAL.

In order to capture relevant log events that would otherwise be lost in typical network configurations, network devices (such as network switch 16 and network switch 18) may be configured to generate log events that are more detailed. In one embodiment, the network devices generate log events according to a source level. As used herein, the source level indicates a level of detail or severity at which log events going into the log buffer are generated. In one embodiment, the log level indicates a level of detail or severity that is equal to or higher than that of the source level. For example, the source level may specify the INFO level. As such, log events are generated for the INFO level and for higher log levels. This creates a thicket of log events, which may be provided to, for example, the local system log and/or Syslog server.

The generated log events may be received by the log buffer of the network device. The log buffer is limited in size, and as such, detailed information may be logged for a short period of time. In other words, the log buffer captures trace log events for a brief time. The log buffer includes a defined window for holding log events. Log events which are deemed relevant may be provided to a system log (i.e., a local system log and/or a Syslog server). As previously described, the window includes an ex-ante window and an ex-post window. The ex-ante window captures log events before the occurrence of an event trigger. The ex-post window captures log events after the occurrence of the event trigger.

The log buffer may be monitored for one or more trigger events. If a trigger event is not detected, the log event is considered not relevant trace data. As in typical logging methodologies, it may be determined whether the log event satisfies the log level and if so, the log event is provided to a system log. Where a trigger event is detected, log events from the ex-ante window in the log buffer are considered to be relevant trace data and are provided, for example, to a system log.

Furthermore, log events for the ex-post window may be provided. For example, a policy dictates that even more detailed information be provided for a period after the trigger event is detected. The more detailed information may be used for purposes of troubleshooting. As such, upon detection, the source level may be adjusted to a more detailed or less severe level according to the policy. For example, a network device may be configured for a source level of NOTICE and reconfigured for a lower-severity log level of DEBUG. The DEBUG log events are provided, for example to the local system log and Syslog server 12.

In one embodiment, a condition detected at one network device may affect and may be affected by the operations of other network devices (e.g., upstream network devices, downstream network devices, neighboring network devices, etc.) in network 100. For purposes of troubleshooting, it may be desirable to collect relevant trace log events of other network devices.

For example, after detection of the trigger event, network switch 16 may transmit a broadcast message to one or more network devices (e.g., network switch 18) in network 100. The broadcast message may request or otherwise trigger the receiving network device to also provide their ex-ante window and/or ex-post window to Syslog server 12. In one embodiment, the broadcast message may be a trigger event for the receiving network device.

In another embodiment, central management server 10 and/or Syslog server 12 may transmit a message to one or more network devices in network 100 upon detection of a triggering event or upon receiving the reported log events from the ex-ante window and/or ex-post window of the network device. The message may request or otherwise trigger the receiving network device to also provide their ex-ante window and/or ex-post window to Syslog server 12. In one embodiment, the message may be a trigger event for the receiving network device.

For example, central management server 10 and/or Syslog server 12 may detect the trigger event, which may be the same or different trigger event used by one or more network devices, such as network switch 16 and network switch 18. Where the log event that resulted in detection of the trigger event occurred in network switch 16, central management server 10 and/or Syslog server 12 may transmit a message to network switch 18 requesting or otherwise triggering network switch 18 to also provide its ex-ante window and/or ex-post window to Syslog server 12.

The present invention can also be applied in other network topologies and environments. Network 100 may be any type of network familiar to those skilled in the art that can support data communications using any of a variety of commercially-available protocols, including without limitation TCP/IP, SNA, IPX, AppleTalk, and the like. Merely by way of example, network 100 can be a local area network (LAN), such as an Ethernet network, a Token-Ring network and/or the like; a wide-area network; a virtual network, including without limitation a virtual private network (VPN); the Internet; an intranet; an extranet; a public switched telephone network (PSTN); an infra-red network; a wireless network (e.g., a network operating under any of the IEEE 802.11 suite of protocols, the Bluetooth protocol known in the art, and/or any other wireless protocol); and/or any combination of these and/or other networks.

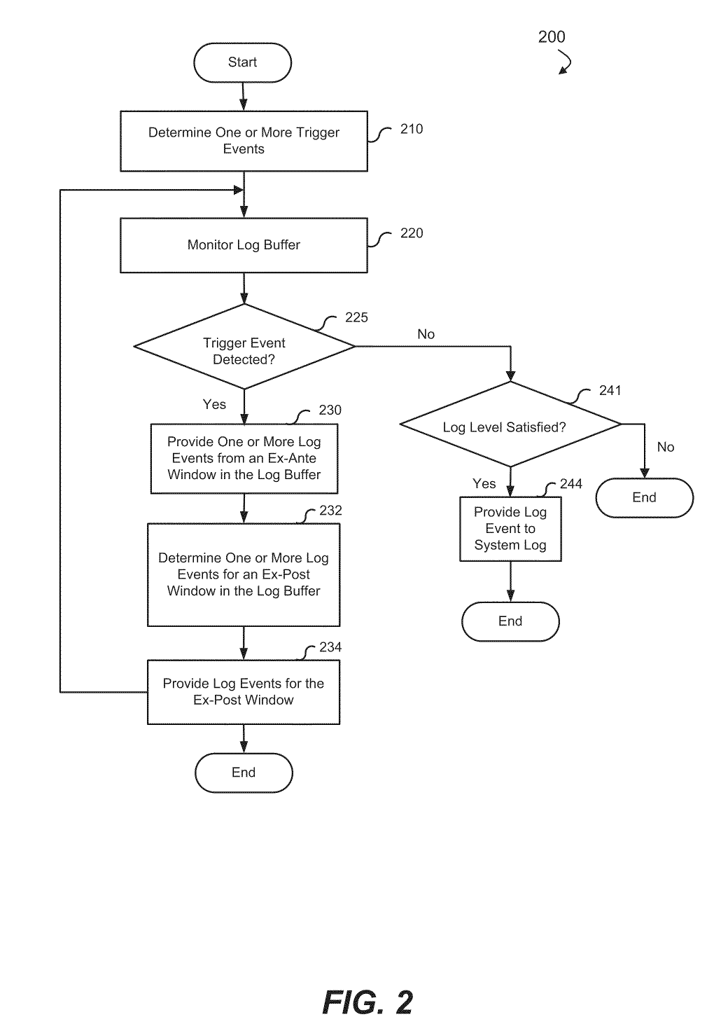

FIG. 2 is a process flow diagram for logging network operation data in accordance with an embodiment of the invention. The depicted process flow 200 is carried out by execution of one or more sequences of executable instructions. In another embodiment, the process flow 200 is carried out by execution of components of a network device (e.g., network switch, central management server, and/or Syslog server) an arrangement of hardware logic, e.g., an Application-Specific Integrated Circuit (ASIC), etc. In another embodiment, the process flow 200 is carried out by a log manager of the network device.

At step 210, one or more trigger events may be determined. The trigger events may be set manually, for example by a network administrator, or set by default. In another embodiment, a trigger event may be determined, for example by a genetic algorithm, by learning the normal operating conditions of the network device and identifying an anomalous event. The anomalous event may be set as a trigger event.

Typically, logging is configured for a high log level (e.g., less detail). In one embodiment, the source level may be configured at a lower level for generation of more granular log events. Moreover, source levels may be determined differently and/or independently for each incoming source.

In one embodiment, network devices may be configured to generate log events according to the source level, for example the NOTICE level. The generated log events may be received by a log buffer of the network device prior to being received by a local system log of the network device. In one embodiment, where the network device is a network switch or other network infrastructure device, the log events are generated by processes running on the network device.

In another embodiment, where the network device is a central management server or other network-connected device, the log events are generated by one or more network infrastructure device in the network and transmitted to the central management server.

At step 220, the log buffer is monitored, for example, for the occurrence of one or more of the trigger events. At step 225, it is determined whether a trigger event is detected. For example, the log buffer may be a first in first out (FIFO) buffer, a queue, a list, a stack, etc. In one embodiment, as log events are enqueued (i.e., placed in the buffer), it is determined whether an arriving log event matches a condition specified in the one or more trigger events. Where a match is determined, a trigger event is detected. The log events in the log buffer may then be considered relevant trace data. At the time of detection, the log events in the log buffer make up an ex-ante window, which may also include the log event that gave rise to the detection of the trigger event.

At step 230, the one or more log events from an ex-ante window in the log buffer are provided, for example to a system log. For example, the log events in the FIFO buffer at the time of detection may be provided to the system log.

Trace events may be determined for an ex-post window. In one embodiment, the source level may be dynamically reconfigured or otherwise modified. The source level may be reconfigured for more or less detailed log data.

In one embodiment, the source level may be modified based on the type of trigger event that was detected at step 225. For example, the trigger event may be security-related, and a policy may dictate that the source level be modified for more detailed log data upon the detection of security-related trigger events. As such, the level of detail of the log events flowing into the log buffer may be modified by adjusting the source level.

Moreover, the source level may be reconfigured to limit the type of log event generated for the ex-post window. For example, it may be determined that the detected trigger event corresponds to log events of a particular process running in the network device, and as such more detailed log events may be generated for that process. In another embodiment, it may be determined that the detected trigger event corresponds to security-related log events, and as such more detailed log events may be generated for security-related log events of the network device.

At step 232, one or more log events for an ex-post window in the log buffer are determined. For example, for a period of time, the log events that arrive in the FIFO buffer after the log event that gave rise to the detection at step 225, may be provided. In one embodiment, a log event for the ex-post window is provided to a system log immediately after arriving in the log buffer. For example, if the FIFO buffer is 50 log events deep, a log event may be provided before waiting to be dequeued after the subsequent arrival of 49 more log events.

In one embodiment, the period of time associated with the ex-post window may be set by default (e.g., 30 seconds, 3 minutes, etc.), configurable, or dynamically determined. For example, the dynamically determined time period may continue until a normal flow of log events are detected. The time period may be configured according to multiple thresholds, for example, one threshold to enable the system to log trace events and another threshold to disable the logging of trace events.

In one embodiment, the ex-post window is not limited by the size of the log buffer. The ex-post window can be defined by one or more of time, event count, or other similar condition.

In one embodiment, the ex-ante window and ex-post window may be determined as a ratio of the number of log events that arrived at the log buffer before the trigger event to the number of log events that arrive after the trigger event. This embodiment may apply where the reconfigured source levels are not employed.

At step 234, the filtered log events for the ex-post window in the log buffer that satisfy the reconfigured log level are provided, for example to a Syslog server. The log events that arrived in the FIFO buffer later in time than the log event which resulted in detection of the trigger event may be provided, for example to the Syslog server. Processing may continue to step 220 where the log buffer is again monitored.

The trigger event may not be detected at step 225. If a trigger event is not detected, the log event is considered not relevant trace data, however, it may be relevant for typical event logging. In one embodiment, it is determined, at step 241, whether a log level is satisfied. For example, if the log event in the log buffer satisfies the log level, the log event may be provided to the system log, at step 244. Otherwise, processing ends and the log event is eventually dequeued and not retained.

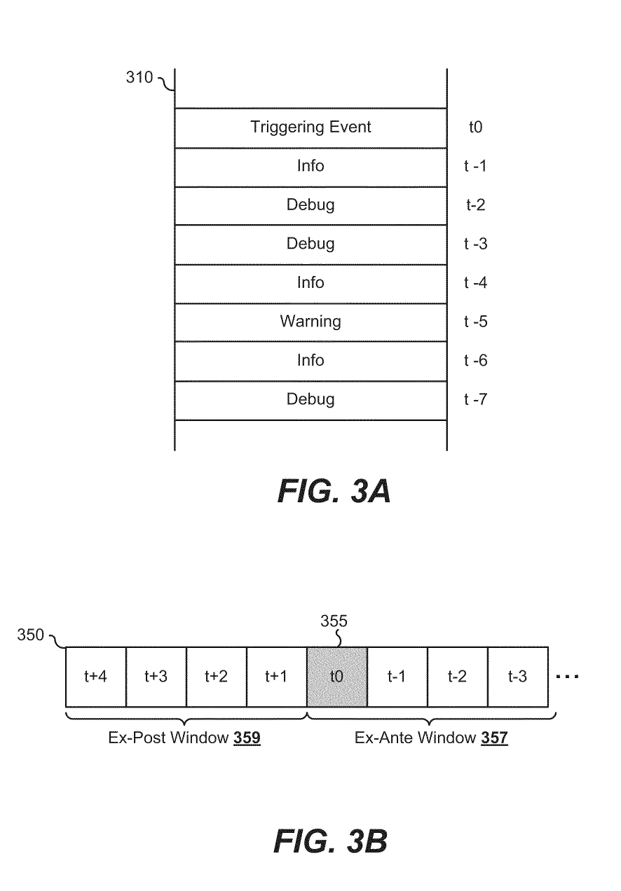

FIG. 3A is a simplified diagram of a log buffer in accordance with an embodiment of the invention. Log buffer 310 is a FIFO buffer with the capacity to hold eight log events. As a log event is enqueued at time t₀, it is determined whether a trigger event is detected. As shown, the log event at time t₀ resulted in detection of the trigger event.

FIG. 3B is a simplified diagram of a flow 350 of log events in accordance with an embodiment of the invention. Flow 350 may include those log events which move through log buffer 310 of FIG. 3A. A trigger event 355 may be detected at time t₀ in the flow, corresponding to time t₀ in log buffer 310. An ex-ante window 357 and an ex-post window 359 are shown. Ex-ante window 357 may correspond with the log events at time t₀-t₃ of log buffer 310. Ex-post window 359 includes log events that are enqueued, but not yet processed, for example by a log manager, after the trigger event. The size of the ex-post window may be equal to, smaller or larger than the capacity of log buffer 310. In other words, the ex-post window is not limited by the capacity of log buffer 310.

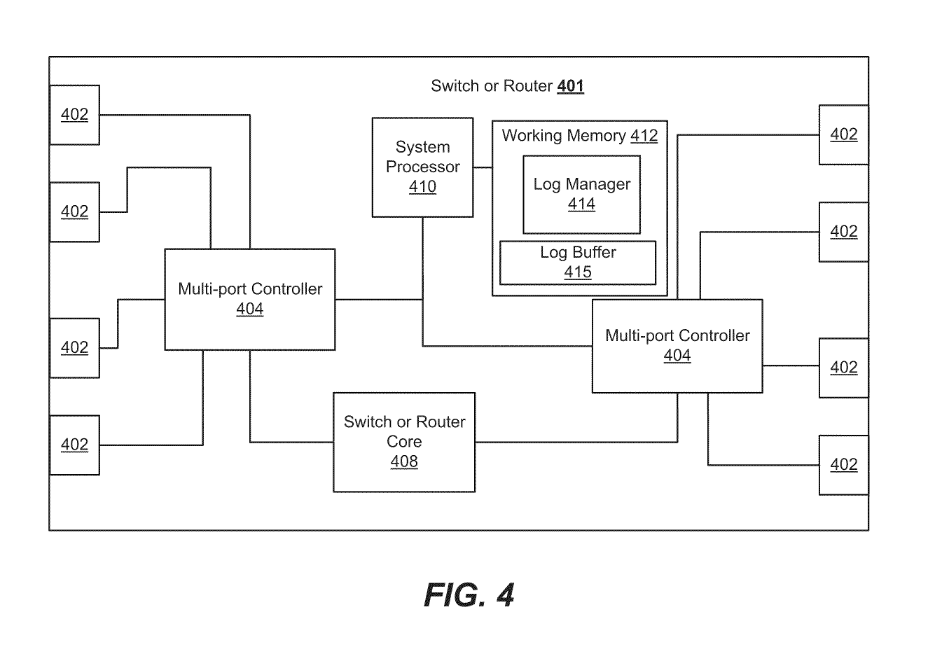

FIG. 4 is a block diagram of an exemplary switching or routing device in accordance with an embodiment of the invention. Switching or routing device 401 may be configured with multiple ports 402. The ports 402 may be controlled by one or more controller ASICs (application specific integrated circuits) 404.

The device 401 may transfer (i.e. “switch” or “route”) packets between ports by way of a conventional switch or router core 408 which interconnects the ports. A system processor 410 and working memory 412 may be used to control device 401. For example, a log manager 414 may be implemented as code in working memory 412 which is being executed by the system processor 410 of device 401. Working memory 412 may also include log buffer 415.

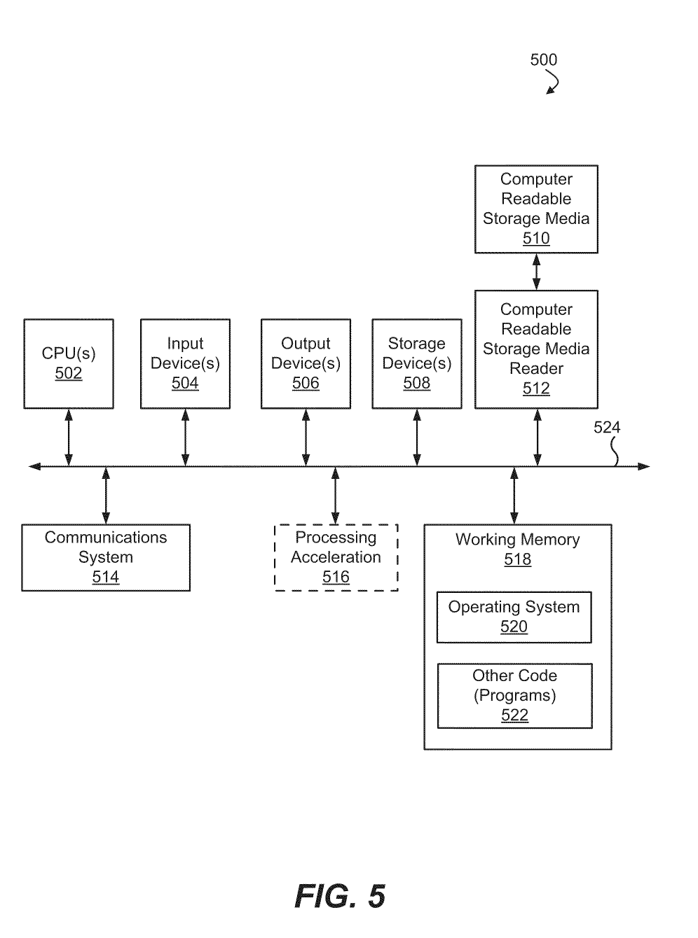

FIG. 5 illustrates an exemplary computer system 500 in which various embodiments of the present invention may be implemented. The system 500 may be used to implement any of the computer systems described above. The computer system 500 is shown comprising hardware elements that may be electrically coupled via a bus 524. The hardware elements may include one or more central processing units (CPUs) 502, one or more input devices 504 (e.g., a mouse, a keyboard, etc.), and one or more output devices 506 (e.g., a display device, a printer, etc.). The computer system 500 may also include one or more storage devices 508. By way of example, the storage device(s) 508 can include devices such as disk drives, optical storage devices, solid-state storage device such as a random access memory (“RAM”) and/or a read-only memory (“ROM”), which can be programmable, flash-updateable and/or the like.

The computer system 500 may additionally include a computer-readable storage media reader 512, a communications system 514 (e.g., a modem, a network card (wireless or wired), an infra-red communication device, etc.), and working memory 518, which may include RAM and ROM devices as described above. In some embodiments, the computer system 500 may also include a processing acceleration unit 516, which can include a digital signal processor DSP, a special-purpose processor, and/or the like.

The computer-readable storage media reader 512 can further be connected to a computer-readable storage medium 510, together (and in combination with storage device(s) 508 in one embodiment) comprehensively representing remote, local, fixed, and/or removable storage devices plus storage media for temporarily and/or more permanently containing, storing, transmitting, and retrieving computer-readable information. The communications system 514 may permit data to be exchanged with the network and/or any other computer described above with respect to the system 500.

The computer system 500 may also comprise software elements, shown as being currently located within a working memory 518, including an operating system 520 and/or other code 522, such as an application program (which may be a client application, Web browser, mid-tier application, etc.). It should be appreciated that alternate embodiments of a computer system 500 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for storing a plurality of instructions, or portions of instructions, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

What is claimed is:

1. A method for logging trace events of a network device in a network, the method comprising:
generating, by the network device, a plurality of log events based on a source level;
storing the plurality of log events to a log buffer of the network device;
monitoring the log buffer for a trigger event, wherein the trigger event is a condition in the network;
determining whether the trigger event is detected;
determining one or more log events of the plurality of log events in an ex-ante window of the log buffer upon detecting the trigger event;
providing a log event of the one or more log events to a system log; and
determining whether the one or more log events of the plurality of log events in the ex-ante window satisfy a log level upon determining the trigger event is not detected, wherein a severity of the source level is lower than a severity of the log level.

2. The method of claim 1, wherein the system log is a local system log of the network device.

3. The method of claim 1, further comprising:
determining one or more log events of the plurality of log events in an ex-post window of the log buffer based on the source level; and
providing a log event of the one or more log events in the ex-post window to a system log.

4. The method of claim 1, further comprising:
reconfiguring the source level;
determining one or more log events of the plurality of log events in an ex-post window of the log buffer based on the reconfigured source level; and
providing a log event of the one or more log events in the ex-post window to a system log.

5. The method of claim 4, wherein reconfiguring the source level includes modifying a severity of the source level.

6. The method of claim 4, wherein determining the one or more log events in the ex-post window is performed for a time period.

7. The method of claim 4, wherein determining the one or more log events in the ex-post window is performed until a normal flow of log events is detected.

8. The method of claim 1, wherein the source level is reconfigured based on a type of the detected trigger event.

9. The method of claim 1, wherein the network device is a network infrastructure device, further comprising:
transmitting a broadcast message across the network, wherein the broadcast message triggers a receiving network device to provide to a system log one or more log events in a log buffer of the receiving device.

10. A system for logging trace events of a network device in a network, the system comprising:
a processor; and
a memory coupled to the processor, the memory configured to store an electronic document;
wherein the processor is configured to:
generate a plurality of log events based on a source level;
store the plurality of log events to a log buffer of the network device;
monitor the log buffer for a trigger event, wherein the trigger event is a condition in the network;
determine whether the trigger event is detected;
determine one or more log events of the plurality of log events in an ex-ante window of the log buffer upon detecting the trigger event;
provide a log event of the one or more log events to a system log; and
determine whether the one or more log events of the plurality of log events in the ex-ante window satisfy a log level upon determining the trigger event is not detected, wherein a severity of the source level is lower than a severity of the log level.

11. The system of claim 10, wherein the system log is a local system log of the network device.

12. The system of claim 10, wherein the processor is configured to:
determine one or more log events of the plurality of log events in an ex-post window or the log buffer based on the source level; and
provide a log event of the one or more log events in the ex-post window to a system log.

13. The system of claim 10, wherein the processor is configured to:
reconfigure the source level;
determine one or more log events of the plurality of log events in an ex-post window of the log buffer based on the reconfigured source level; and
provide a log event of the one or more log events in the ex-post window to a system log.

14. The system of claim 10, wherein the processor is configured to:
transmit a broadcast message across the network, wherein the broadcast message triggers a receiving network device to provide to a system log one or more log events in a log buffer of the receiving device.

15. A computer-readable medium storing a plurality of instructions for controlling a data processor for logging trace events of a network device in a network, the plurality of instructions comprising:
instructions that cause the data processor to generate a plurality of log events based on a source level;
instructions that cause the data processor to store the plurality of log events to a log buffer of the network device;
instructions that cause the data processor to monitor the log buffer for a trigger event, wherein the trigger event is a condition in the network;
instructions that cause the data processor to determine whether the trigger event is detected;
instructions that cause the data processor to determine one or more log events of the plurality of log events in an ex-ante window of the log buffer upon detecting the trigger event;
instructions that cause the data processor to provide a log event of the one or more log events to a system log; and
instructions that cause the data processor to determine whether the one or more log events of the plurality of log events in the ex-ante window satisfy a log level upon determining the trigger event is not detected, wherein a severity of the source level is lower than a severity of the log level.

16. The computer-readable medium of claim 15, wherein the system log is a local system log of the network device.

17. The computer-readable medium of claim 15, wherein the plurality of instructions further comprise:
instructions that cause the data processor to determine one or more log events of the plurality of log events in an ex-post window of the log buffer based on the source level; and
instructions that cause the data processor to provide a log event of the one or more log events in the ex-post window to a system log.

18. The computer-readable medium of claim 15, wherein the plurality of instructions further comprise:
instructions that cause the data processor to reconfigure the source level;
instructions that cause the data processor to determine one or more log events of the plurality of log events in an ex-post window of the log buffer based on the reconfigured source level; and
instructions that cause the data processor to provide a log event of the one or more log events in the ex-post window to a system log.

19. The computer-readable medium of claim 18, wherein the source level is reconfigured based on a type of the detected trigger event.

20. The computer-readable medium of claim 15, wherein the plurality of instructions further comprise instructions that cause the data processor to transmit a broadcast message across the network, wherein the broadcast message triggers a receiving network device to provide to a system log one or more log events in a log buffer of the receiving device.
